(19) United States
(12) Patent Application Publication
(10) Pub. No.: US 2021/0209984 A1
(43) Pub. Date: Jul. 8, 2021

(54) CIRCUIT FOR SOLVING ELECTROMAGNETIC INTERFERENCE SIGNAL

(71) Applicant: TCL China Star Optoelectronics Technology Co., Ltd., Shenzhen Guangdong (CN)

(72) Inventor: Xiaoli FU, Shenzhen (CN)

(73) Assignee: TCL China Star Optoelectronics Technology Co., Ltd., Shenzhen (CN)

(21) Appl. No.: 16/623,772

(22) PCT Filed: Nov. 21, 2019
(86) PCT No.: PCT/CN2019/119927

§ 371 Date: Dec. 18, 2019

(30) Foreign Application Priority Data
Oct. 15, 2019 (CN) 201910979015.X

(51) Int. Cl. G09G 3/20

(52) U.S. Cl. CPC G09G 3/20; G09G 2310/06; G09G 2310/0275; G09G 2330/06

(57) ABSTRACT

The present disclosure provides a circuit for solving electromagnetic interference signal including a source driving chip, a plurality of first switching units, and a delay control unit. The source driving chip includes a plurality of the output passageway connected to a corresponding row of pixel electrodes in a glass substrate through the data lines and configured to output a charging signal in order to charge the pixel electrodes. The first switch units are correspondingly disposed on each output passageways and connected to the corresponding delay control unit to control the output passageways provided with the first switching units to output the charging signal at a predetermined delay time according to a delay control signal generated by the delay control unit. The connection between the delay control unit and the internal of the source driving chip can reduce manufacturing costs and electromagnetic interference of the display panel circuit.

### FIELD OF INVENTION

The present disclosure relates to the field of display technologies, more particularly to a circuit for solving electromagnetic interference signal.

### BACKGROUND OF INVENTION

In order to reduce the electromagnetic interference (EMI) energy, source driving chip internally divides all source outputs into different groups for fanning out. Each group has differential times. The more the number of groups that the source outputs are divided into, the more dispersed the energy is, and the lower the electromagnetic field interference energy is. Thus, the electromagnetic field interference is reduced more easily. But the more the group is divided, the larger area the integrated circuit (IC) die has.

### Technical Problems

Cost reduction has become an important development for every manufacturer with growing competition in the display panel industries. In order to meet the cost reduction of manufacturers, die shrinking has become an important solution to reduce cost for chip on film (COF) manufacturers.

However, during die shrinking processed by COF manufacturers, side effects occur and problems caused from electromagnetic field interference are worsened.

Before die shrinking, the source outputs are divided into 10 groups due to the sufficient die area. When die shrinking is implemented, source outputs are divided into only 4 groups, which eliminates 6 groups of delay circuit unit. Cost reduction can achieve by die shrinking because areas are reduced. However, shrinking into four groups will worsen the problems of electromagnetic field interference.

Thus, the main object of the present disclosure is providing a circuit for solving electromagnetic interference signal to improve the above-mentioned problems.

### SUMMARY OF INVENTION

To solve the above-mentioned technical problems, the object of the present disclosure is providing a circuit for solving electromagnetic interference signal comprising a source driving chip, a plurality of first switching units, and a delay control unit. The source driving chip comprises a plurality of output passageways connected to a corresponding row of pixel electrodes in a glass substrate through data lines and configured to output a charging signal in order to charge a corresponding row of the pixel electrodes. The first switch units are correspondingly disposed on each of the output passageways and connected to the corresponding delay control unit to control the output passageways provided with the first switching units to output the charging signal at a predetermined delay time according to a delay control signal generated by the delay control unit. The delay control unit is configured to generate the corresponding delay control signals to control the corresponding first switching units to be turned on at the predetermined delay time to make charging durations of each of the pixel electrodes being equal according to impedances of the corresponding data lines.

The purpose of the present disclosure and an object of solving the technical problems are achieved by the following technical solutions.

In an embodiment of the present disclosure, a first end of the delay control unit is electrically coupled to a first group unit, a second end of the delay control unit is electrically coupled to a second group unit, a third end of the delay control unit is electrically coupled to a third group unit, a fourth end of the delay control unit is electrically coupled to a fourth group unit, a fifth end of the delay control unit is electrically coupled to a fifth group unit, a sixth end of the delay control unit is electrically coupled to a sixth group unit, a seventh end of the delay control unit is electrically coupled to the seventh group unit, an eighth end of the delay control unit is electrically coupled to an eighth group unit, a ninth end of the delay control unit is electrically coupled to a ninth group unit, and a tenth end of the delay control unit is electrically coupled to a tenth group unit.

In an embodiment of the present disclosure, a first end of the first group unit is electrically coupled to a first output node, a (N+1)th end of the first group unit is electrically coupled to a (N+1)th output node, and 1≤N<144.

In an embodiment of the present disclosure, a first end of the second group unit is electrically coupled to a 144th output node, a (N+1)th end of the second group unit is electrically coupled to a (N+1)th output node, and 144≤N<288.

In an embodiment of the present disclosure, a first end of the third group unit is electrically coupled to a 288th output node, a (N+1)th end of the third group unit is electrically coupled to a (N+1)th output node, and 288≤N<432.

In an embodiment of the present disclosure, a first end of the fourth group unit is electrically coupled to a 432th output node, a (N+1)th end of the fourth group unit is electrically coupled to a (N+1)th output node, and 432≤N<576.

In an embodiment of the present disclosure, a first end of the fifth group unit is electrically coupled to a 576th output node, a (N+1)th end of the fifth group unit is electrically coupled to a (N+1)th output node, and 576≤N<720.

In an embodiment of the present disclosure, a first end of the sixth group unit is electrically coupled to a 720th output node, a (N+1)th end of the sixth group unit is electrically coupled to a (N+1)th output node, and 720≤N<864.

In an embodiment of the present disclosure, a first end of the seventh group unit is electrically coupled to an 864th output node, a (N+1)th end of the seventh group unit is electrically coupled to a (N+1)th output node, and 864≤N<1008.

In an embodiment of the present disclosure, a first end of the eighth group unit is electrically coupled to a 1008th output node, a (N+1)th end of the eighth group unit is electrically coupled to a (N+1)th output node, and 1008≤N<1152.

In an embodiment of the present disclosure, a first end of the ninth group unit is electrically coupled to a 1152th output node, a (N+1)th end of the ninth group unit is electrically coupled to a (N+1)th output node, and 1152≤N<1296.

In an embodiment of the present disclosure, a first end of the tenth group unit is electrically coupled to a 1296th output node, a (N+1)th end of the tenth group unit is electrically coupled to a (N+1)th output node, and 1296≤N<1440.

The present disclosure patent can reduce the manufacturing cost of the panels and reduce the influence resulted from electromagnetic interference in the display panel circuits by utilizing the circuit for solving electromagnetic interference signal.

### DESCRIPTION OF DRAWINGS

In order to clarify the technical solutions of embodiments of the present disclosure, drawings required to describe the embodiments are briefly illustrated. Obviously, the mentioned embodiments are only parts of the embodiments instead of all of the embodiments. Other embodiments can be obtained by a skilled person in the art without creative effort fall in the protected scope of the present disclosure.

FIG. 1a is an exemplary data analysis diagram of the relationship between a number of groups and electromagnetic interference energy in a source driving chip.

FIG. 1b is a data analysis diagram of relationship between a number of groups and electromagnetic interference energy in a source driving chip pf an embodiment of the present disclosure.

FIG. 2 is a schematic structural diagram of the source driving chip connecting to pixel regions through data lines of the embodiment of the present disclosure.

FIG. 3 is a schematic diagram of a circuit for solving electromagnetic interference signal with a delay control unit of the embodiment of the present disclosure.

### DETAILED DESCRIPTION OF PREFERRED EMBODIMENTS

The following description of the various embodiments is provided with reference of drawings to illustrate specific embodiments. Directional terms mentioned in the present disclosure, such as upper, lower, front, back, left, right, inside, outside, lateral, etc., are only referring to the direction of the drawing. Therefore, the directional terms used to describe and clarify the present disclosure should not be viewed as limitations of the present disclosure. In the drawing, similar elements are denoted by the same reference numbers.

The drawings and the description are illustrative rather than restrictive. In the drawings, elements having similar structure are denoted by the same reference numbers. In addition, the size and thickness of each component shown in the drawings are illustrative for understanding and convenience of description. However, the present disclosure is not limited thereto.

In the drawings, the thicknesses of layers, films, panels, regions, etc. are exaggerated for clarity. In the drawings, the thickness of some layers and regions are exaggerated for the purposes of illustration and description. It will be understood that when a component such as a layer, a film, a region or a substrate is “on” another component, the component can be directly on the other component or an intermediate component can also exist.

In addition, in the specification, the word “comprising” is to be understood to include the component, but does not exclude any other component. Further, in the specification, “on” means locating above or below the target component instead of meaning on upper direction against gravity.

In order to further clarity the technical objections and functions of the present disclosure for achieving the intended purpose of the present disclosure, the circuit for solving electromagnetic interference signal according to the present disclosure will be described below accompanying with drawings and specific embodiments. Structures, characteristics, and effects are described below in detail.

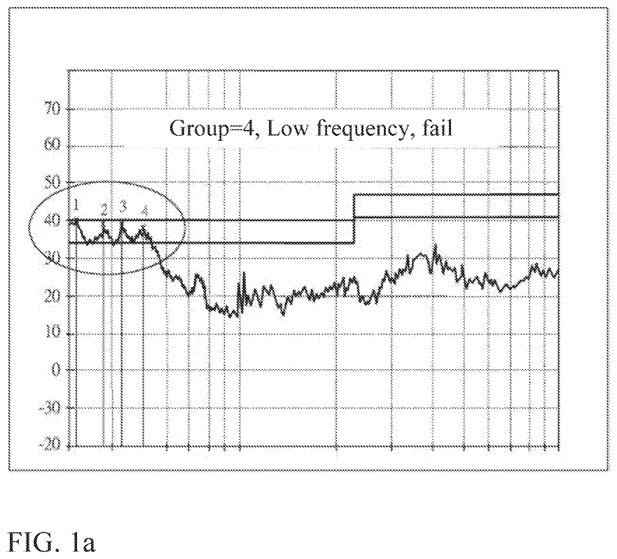

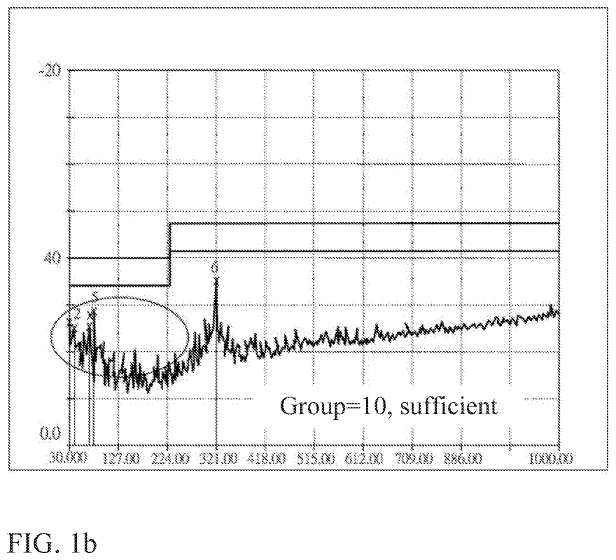

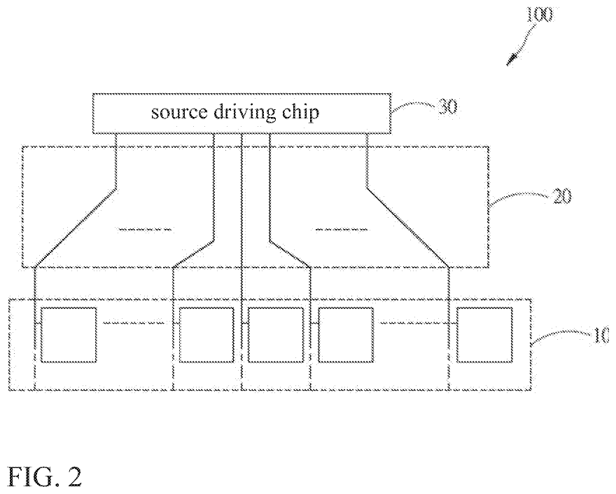

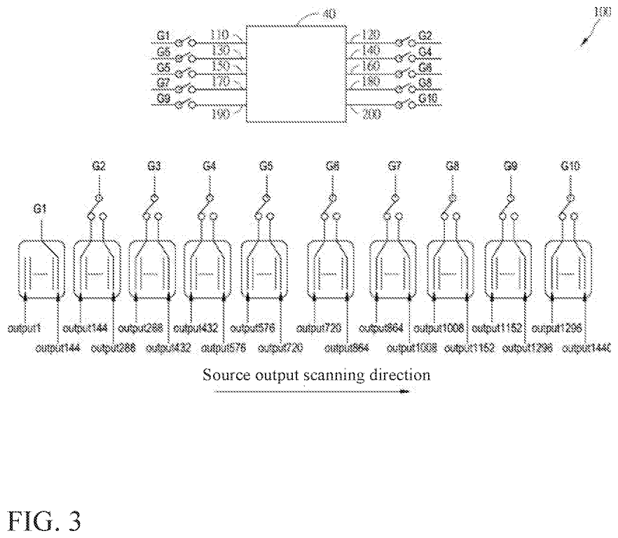

FIG. 1a is an exemplary data analysis diagram of the relationship between a number of groups and electromagnetic interference energy in a source driving chip. FIG. 1b is a data analysis diagram of relationship between a number of groups and electromagnetic interference energy in a source driving chip pf an embodiment of the present disclosure. FIG. 2 is a schematic structural diagram of the source driving chip connecting to pixel regions through data lines of the embodiment of the present disclosure. FIG. 3 is a schematic diagram of a circuit for solving electromagnetic interference signal with a delay control unit of the embodiment of the present disclosure. Please refer to FIG. 1a, FIG. 1b, and FIG. 3. As shown in FIG. 1a, in order to reduce electromagnetic interference energy, the source driving chip divides 1440 channels of source outputs into 10 groups, so that there will be 9 delay units which make die areas larger.

In order to reduce the die areas, a number of groups is reduced from 10 to 4. Although the die areas are reduced, electromagnetic interference margin is insufficient due to excessive concentration of electromagnetic interference energy. Thus, the electromagnetic interference test fails. Therefore, the delay control unit is multiplexed as shown in FIG. 1b and FIG. 3. On the basis of utilizing only one delay control unit, the 1440 channels are divided into 10 groups to disperse the electromagnetic interference energy. As a result, low frequency electromagnetic interference has sufficient margin and the test result of electromagnetic interference is finally passed.

Please refer to FIG. 2 and FIG. 3. In an embodiment of the present disclosure, the source driving chip 30 connects to pixel regions 10 through a plurality of data lines 20 (indicated as n in the figure, n is a natural number) for charging pixel electrodes in the pixel regions 10. By controlling output times of each of output passageways through a delay control unit 40, the output times of each of the output passageways corresponds and matches the impedance value of the data lines 20. Therefore, times of each of the output passageways in the pixel regions for charging a row of the pixel electrodes are ensured to be the same, thereby display is uniform.

Please refer to FIG. 2 and FIG. 3. In an embodiment of the present disclosure, a circuit for solving electromagnetic interference signal 100 includes the source driving chip 30, a plurality of the first switching units (not shown), and the delay control unit 40. The source driving chip 30 includes a plurality of output passageways connected to a corresponding row of pixel electrodes 10 in a glass substrate through the data lines 20 and configured to output a charging signal in order to charge a corresponding row of the pixel electrodes 10. The first switch units are correspondingly disposed on each of the output passageways and connected to the corresponding delay control unit 40 to control the output passageways provided with the first switching units to output the charging signal at a predetermined delay time according to a delay control signal generated by the delay control unit 40. The delay control unit 40 is configured to generate the corresponding delay control signals to control the corresponding first switching units to be turned on at the predetermined delay time to make charging durations of each of the pixel electrodes 10 being equal according to impedances of the corresponding data lines 20. A first end 110 of the delay control unit 40 is electrically coupled to a first group unit G1. A second end 120 of the delay control unit 40 is electrically coupled to a second group unit G2. A third end 130 of the delay control unit 40 is electrically coupled to a third group unit G3. A fourth end 140 of the delay control unit 40 is electrically coupled to a fourth group unit G4. A fifth end 150 of the delay control unit is electrically coupled to a fifth group unit G5. A sixth end 160 of the delay control unit 40 is electrically coupled to a sixth group unit G6. A seventh end 170 of the delay control unit 40 is electrically coupled to the seventh group unit G7. An eighth end 180 of the delay control unit 40 is electrically coupled to an eighth group unit G8. A ninth end 190 of the delay control unit 40 is electrically coupled to a ninth group unit G9. A tenth end 200 of the delay control unit 40 is electrically coupled to a tenth group unit G10.

Please refer to FIG. 3. In an embodiment of the present disclosure, a first end of the first group unit G1 is electrically coupled to a first output node 1. A (N+1)th end of the first group unit G1 is electrically coupled to a (N+1)th output node, where 1≤N<144.

Please refer to FIG. 3. In an embodiment of the present disclosure, a first end of the second group unit G2 is electrically coupled to a 144th output node. A (N+1)th end of the second group unit G2 is electrically coupled to a (N+1)th output node, where 144≤N<288.

Please refer to FIG. 3. In an embodiment of the present disclosure, a first end of the third group unit G3 is electrically coupled to a 288th output node. A (N+1)th end of the third group unit G3 is electrically coupled to a (N+1)th output node, where 288≤N<432.

Please refer to FIG. 3. In an embodiment of the present disclosure, a first end of the fourth group unit G4 is electrically coupled to a 432th output node. A (N+1)th end of the fourth group unit G4 is electrically coupled to a (N+1)th output node, where 432≤N<576.

Please refer to FIG. 3. In an embodiment of the present disclosure, a first end of the fifth group unit G5 is electrically coupled to a 576th output node. A (N+1)th end of the fifth group unit G5 is electrically coupled to a (N+1)th output node, where 576≤N<720.

Please refer to FIG. 3. In an embodiment of the present disclosure, a first end of the sixth group unit G6 is electrically coupled to a 720th output node. A (N+1)th end of the sixth group unites G6 is electrically coupled to a (N+1)th output node, where 720≤N<864.

Please refer to FIG. 3. In an embodiment of the present disclosure, a first end of the seventh group unit G7 is electrically coupled to a 864th output node. A(N+1)th end of the seventh group unit G7 is electrically coupled to a (N+1)th output node, where 864≤N<1008.

Please refer to FIG. 3. In an embodiment of the present disclosure, a first end of the eighth group unit G8 is electrically coupled to a 1008th output node. A (N+1)th end of the eighth group unit G8 is electrically coupled to a (N+1)th output node, where 1008≤N<1152.

Please refer to FIG. 3. In an embodiment of the present disclosure, a first end of the ninth group unit G9 is electrically coupled to a 1152th output node. A (N+1)th end of the ninth group unit G9 is electrically coupled to a (N+1)th output node, where 1152≤N<1296.

Please refer to FIG. 3. In an embodiment of the present disclosure, a first end of the tenth group unit G10 is electrically coupled to a 1296th output node. A (N+1)th end of the tenth group unit G10 is electrically coupled to a (N+1)th output node, where 1296≤N<1440.

The present disclosure can reduce the manufacturing cost of the panela and reduce the influence of electromagnetic interference in the display panel circuits by utilizing the circuit for solving electromagnetic interference signal.

Terms such as “in some embodiments” and “in each of the embodiments” are used repeatedly. The term generally does not refer to the same embodiment; however, it can also refer to the same embodiment. Terms such as “including”, “having” and “comprising” are synonymous, unless the context is intended to refer to other meaning.

To conclude, the above is only embodiments of the present disclosure rather than any types of restrictions. Although the present disclosure has been disclosed by above-mentioned specific embodiments, the above-mentioned specific embodiments are not limitations to the present disclosure. Variations and modifications may be easily obtained by a person skilled in the art without departing from the technical solutions of the present disclosure. Easy modifications, equivalent modifications, and modification of the present disclosure which can be obtained according to the above-mentioned technical solutions without departing from the technical solutions of the present disclosure fall in the protected scope of the present disclosure. cl INDUSTRIAL APPLICABILITY

The subject matter of the present disclosure can be manufactured and used in the industry with industrial applicability.

What is claimed is:

1. A circuit for solving electromagnetic interference signal, comprising:
a source driving chip, a plurality of first switching units, and a delay control unit,
wherein the source driving chip comprises a plurality of output passageways connected to a corresponding row of pixel electrodes in a glass substrate through data lines and configured to output a charging signal in order to charge a corresponding row of the pixel electrodes;
wherein the first switch units are correspondingly disposed on each of output passageways and connected to a corresponding delay control unit to control the output passageways provided with the first switching units to output the charging signal at a predetermined delay time according to a delay control signal generated by the delay control unit; and
wherein the delay control unit is configured to generate corresponding delay control signals according to impedances of the corresponding data lines to control the corresponding first switching units to be turned on at the predetermined delay time to make charging durations of each of the pixel electrodes being equal.

2. The circuit for solving electromagnetic interference signal according to claim 1, wherein a first end of the delay control unit is electrically coupled to a first group unit, a second end of the delay control unit is electrically coupled to a second group unit, a third end of the delay control unit is electrically coupled to a third group unit, a fourth end of the delay control unit is electrically coupled to a fourth group unit, a fifth end of the delay control unit is electrically coupled to a fifth group unit, a sixth end of the delay control unit is electrically coupled to a sixth group unit, a seventh end of the delay control unit is electrically coupled to the seventh group unit, an eighth end of the delay control unit is electrically coupled to an eighth group unit, a ninth end of the delay control unit is electrically coupled to a ninth group unit, and a tenth end of the delay control unit is electrically coupled to a tenth group unit.

3. The circuit for solving electromagnetic interference signal according to claim 2, wherein a first end of the first group unit is electrically coupled to a first output node, a (N+1)th end of the first group unit is electrically coupled to a (N+1)th output node, and 1 [symbol] N<144.

4. The circuit for solving electromagnetic interference signal according to claim 2, wherein a first end of the second group unit is electrically coupled to a 144th output node, a (N+1)th end of the second group unit is electrically coupled to a (N+1)th output node, and 144 [symbol] N<288.

5. The circuit for solving electromagnetic interference signal according to claim 2, wherein a first end of the third group unit is electrically coupled to a 288th output node, a (N+1)th end of the third group unit is electrically coupled to a (N+1)th output node, and 288 [symbol] N<432.

6. The circuit for solving electromagnetic interference signal according to claim 2, wherein a first end of the fourth group unit is electrically coupled to a 432th output node, a (N+1)th end of the fourth group unit is electrically coupled to a (N+1)th output node, and 432 [symbol] N<576.

7. The circuit for solving electromagnetic interference signal according to claim 2, wherein a first end of the fifth group unit is electrically coupled to a 576th output node, a (N+1)th end of the fifth group unit is electrically coupled to a (N+1)th output node, and 576 [symbol] N<720.

8. The circuit for solving electromagnetic interference signal according to claim 2, wherein a first end of the sixth group unit is electrically coupled to a 720th output node, a (N+1)th end of the sixth group unit is electrically coupled to a (N+1)th output node, and 720 [symbol] N<864.

9. The circuit for solving electromagnetic interference signal according to claim 2, wherein a first end of the seventh group unit is electrically coupled to a 864th output node, a (N+1)th end of the seventh group unit is electrically coupled to a (N+1)th output node, and 864 [symbol] N<1008.

10. The circuit for solving electromagnetic interference signal according to claim 2, wherein a first end of the eighth group unit is electrically coupled to a 1008th output node, a (N+1)th end of the eighth group unit is electrically coupled to a (N+1)th output node, and 1008 [symbol] N<1152;
a first end of the ninth group unit is electrically coupled to a 1152th output node, a (N+1)th end of the ninth group unit is electrically coupled to a (N+1)th output node, and 1152 [symbol] N<1296; and
a first end of the tenth group unit is electrically coupled to a 1296th output node, a (N+1)th end of the tenth group unit is electrically coupled to a (N+1)th output node, and 1296 [symbol] N<1440.
